(19) United States
(12) Patent Application Publication
(10) Pub. No.: US 2014/0074334 A1
(43) Pub. Date: Mar. 13, 2014

(54) ENGINE START CONTROL DEVICE FOR HYBRID VEHICLE

(71) Applicants: Masaaki Tagawa, Hamamatsu-shi (JP); Yoshiki Ito, Hamamatsu-shi (JP); Masakazu Saito, Hamamatsu-shi (JP); Hitoshi Ohkuma, Hamamatsu-shi (JP); Yukihiro Hosoe, Hamamatsu-shi (JP)

(72) Inventors: Masaaki Tagawa, Hamamatsu-shi (JP); Yoshiki Ito, Hamamatsu-shi (JP); Masakazu Saito, Hamamatsu-shi (JP); Hitoshi Ohkuma, Hamamatsu-shi (JP); Yukihiro Hosoe, Hamamatsu-shi (JP)

(21) Appl. No.: 14/000,050

(22) PCT Filed: Feb. 25, 2011
(86) PCT No.: PCT/JP2011/054323

§ 371 Date: Nov. 22, 2013

(51) Int. Cl. B60W 20/00; B60W 10/08; B60W 10/06

(52) U.S. Cl. CPC B60W 20/40; B60W 10/06; B60W 10/08; Y10S 903/93
USPC 701/22; 180/65.265; 903/930

(57) ABSTRACT

An object of the present invention is to start an engine while outputting a driving force requested from a driver. According to the present invention, there is provided an engine start control device of a hybrid vehicle including: a start-time target engine rotation speed calculating means; a start-time target engine torque calculating means; a target engine power calculating means that calculates target engine power based on the target engine rotation speed and the target engine torque; an accelerator operation amount detecting means; a vehicle speed detecting means; a target driving power calculating means that calculates target driving power based on the amount of the operation of the accelerator and the vehicle speed; a target electric power calculating means that sets a difference between the target driving power and the target engine power as target electric power; and a motor torque instruction value calculating means that calculates instruction torque values of a plurality of motor generators using a torque balance equation including the target engine torque and an electric power balance equation including the target electric power.

### TECHNICAL FIELD

The present invention relates to an engine start control device for a hybrid vehicle that includes a plurality of power sources, combines the power thereof using a differential gear mechanism, and inputs or outputs the combined power to or from a driving shaft, and more particularly, to an engine start control device for a hybrid vehicle that can appropriately control the power at the time of starting an engine.

### BACKGROUND ART

Conventionally, as a form of a hybrid vehicle including an electric motor and an engine other than a serial form and a parallel form, as disclosed in Japanese Patent Application Laid-Open (JP-A) Nos. 9-170533, 10-325345, and the like, there is a form in which the torque of the power of the engine is converted by dividing the power of the engine to a power generator and a driving shaft using one planetary gear mechanism (a differential gear mechanism having three rotating components) and two electric motors and driving an electric motor arranged at the driving shaft by using electric power generated by the power generator. This will be referred to as a “three-axis type”.

According to this conventional technology, the engine operating point of the engine can set to an arbitrary point including stop, and accordingly, the fuel efficiency can be improved. However, although not as much as for the serial form, since an electric motor having relatively high torque is necessary for acquiring sufficient driving-shaft torque, and the amount of transmission and reception of electric power between the power generator and the electric motor increases in a low gear ratio region, the electric loss increases, and there is still a room for improvement.

As methods for solving this point, there are methods disclosed in U.S. Pat. No. 3,578,451 and JP-A No. 2002-281607 applied by the applicants of the present invention.

In the method disclosed in JP-A No. 2002-281607, a driving shaft connected to an output shaft of an engine, a first motor generator (hereinafter, referred to as “MG1”), a second motor generator (hereinafter, referred to as “MG2”), and a drive wheel is connected to each rotating component of a differential gear mechanism having four rotating components, the power of the engine and the power of the MG1 and MG2 are combined, and the combined power is output to the driving shaft.

In addition, in the method disclosed in JP-A No. 2002-281607, by arranging an output shaft of an engine and a driving shaft connected to a drive wheel in a rotating component arranged on the inner side on an alignment chart and arranging the MG1 (the engine side) and MG2 (the driving shaft side) in a rotating component disposed on the outer side on the alignment chart, the ratio of power that is in charge of the MG1 and MG2 to the power delivered to the driving shaft from the engine can decrease, whereby the MG1 and MG2 can be miniaturized, and the transmission efficiency of the drive device can be improved. This will be referred to as a “four-axis type”.

In addition, a method disclosed in U.S. Pat. No. 3,578,451 similar to the above-described method has been proposed, in which an additional fifth rotating component is included, and a brake stopping this rotating component is arranged.

In the conventional three-axis type technology described above, as disclosed in JP-A No. 9-170533, in a case where an engine starting determination is made, the engine is driven by the MG1, and the MG2 is controlled so as to offset a driving force generated at the driving shaft due to a reaction force or the like, whereby variations in the torque of the driving shaft at the time of starting the engine are suppressed. In addition, in JP-A No. 10-325345, in a case where an engine start determination is made, control of the MG1 is performed such that the rotation speed of the MG1 becomes a target rotation speed so as to start the engine, and variations in the torque due to driving of the MG1 are corrected by the MG2, whereby variations in the torque of the driving shaft at the time of starting the engine are suppressed.

### CITATION LIST

### Patent Literature

[PTL 1] JP-A No. 9-170533
[PTL 2] JP-A No. 10-325345
[PTL 3] U.S. Pat. No. 3,578,451
[PTL 4] JP-A No. 2002-281607

### SUMMARY OF INVENTION

### Technical Problem

However, in a conventional engine start control device for a hybrid vehicle, in the case of the “three-axis type”, the torque of the MG2 has no influence on the torque balance, and accordingly, by calculating reaction torque output to the driving shaft from the engine and the MG1 based on the torque of the MG1 that is output for starting the engine and controlling the torque of the MG2 so as to offset the reaction torque, the engine can be started without any variation in the torque of the driving shaft.

However, in the case of the “four-axis type”, the driving shaft and the MG2 configure mutually-different shafts, and the torque of the MG2 has influence on the torque balance. Accordingly, there is a problem in that the control method for the “three-axis type” may not be used.

In addition, regarding the control of the “four-axis type”, a method as below has been applied by the applicants of the present invention.

In this application, in a hybrid vehicle that combines the output of an engine and the power of MG1 and MG2 and drives a driving shaft connected to drive wheels, a driving force value to which a power assistance portion according to electric power is added is set as a maximum value of a target driving force in advance, target driving power is acquired based on the target driving force having the amount of operation of the accelerator and a vehicle speed as parameters and the vehicle speed, a value acquired by adding target charge/discharge power acquired based on the charge state SOC of the battery to the target driving power and a maximum output that can be output by the engine are compared with each other, and a lesser value is acquired as the target engine power, a target engine operating point is acquired based on the target engine power, target electric power that is a target value of input/output electric power of the battery is acquired based on a difference between the target driving power and the target engine power, and control instruction values (torque instruction values) of MG1 torque and MG2 torque are calculated by using a torque balance equation including the target engine torque and an electric power balance equation including the target electric power are calculated.

However, also in this method, while the torque can be appropriately controlled in the “four-axis” type, control relating to engine starting is not mentioned, and there is still a room for the improvement.

An object of the present invention is to start an engine while a driving force requested from a driver is output.

### Solution to Problem

According to the present invention, there is provided an engine start control device of a hybrid vehicle that controls driving of the vehicle using outputs of an engine and a plurality of motor generators. The engine start control device includes: a start-time target engine rotation speed calculating means that calculates a target engine rotation speed at the time of starting the engine; a start-time target engine torque calculating means that calculates torque required for cranking the engine; a target engine power calculating means that calculates target engine power based on the target engine rotation speed calculated by the start-time target engine rotation speed calculating means and the target engine torque calculated by the start-time target engine torque calculating means; an accelerator operation amount detecting means that detects an amount of an operation of an accelerator of the vehicle; a vehicle speed detecting means that detects a vehicle speed; a target driving power calculating means that calculates target driving power based on the amount of the operation of the accelerator detected by the accelerator operation amount detecting means and the vehicle speed detected by the vehicle speed detecting means; a target electric power calculating means that sets a difference between the target driving power calculated by the target driving power calculating means and the target engine power calculated by the target engine power calculating means as target electric power; and a motor torque instruction value calculating means that calculates instruction torque values of a plurality of motor generators using a torque balance equation including the target engine torque and an electric power balance equation including the target electric power.

### Advantageous Effects of Invention

According to the present invention, an engine can be started while a driving force requested from a driver is output.

### BRIEF DESCRIPTION OF DRAWINGS

FIG. 1 is a system configuration diagram of an engine start control device for a hybrid vehicle.

FIG. 2 is a control block diagram of calculating a start-time target engine rotation speed, start-time target engine torque, and target electric power.

FIG. 3 is a control block diagram of calculating a torque instruction value of a motor generator.

FIG. 4 is a control flowchart of calculating a target engine operating point.

FIG. 5 is a control flowchart of calculating a torque instruction value of a motor generator.

FIG. 6 is a target driving force search map according to a vehicle speed and the accelerator opening degree.

FIG. 7 is a target charge/discharge power search table according to the charge state of a battery.

FIG. 8 is a target engine operating point search map according to engine torque and an engine rotation speed.

FIG. 9 is an alignment chart in a case where the vehicle speed is changed at the same engine operating point.

FIG. 10 is a diagram that illustrates a line of the highest engine efficiency and a line of the highest total efficiency in a target engine operating point search map formed by engine torque and an engine rotation speed.

FIG. 11 is a diagram that illustrates the efficiency on an equi-power line formed by efficiency and an engine rotation speed.

FIG. 12 is an alignment chart of points (D, E, and F) on an equi-power line.

FIG. 13 is an alignment chart of the state of a low gear ratio.

FIG. 14 is an alignment chart of the state of an intermediate gear ratio.

FIG. 15 is an alignment chart of the state of a high gear ratio.

FIG. 16 is an alignment chart of the state in which power circulation occurs.

FIG. 17 is an alignment chart at the time of starting an engine.

FIG. 18 is a start-time target engine torque search map according to an engine rotation speed.

### DESCRIPTION OF EMBODIMENTS

Hereinafter, an embodiment of the present invention will be described with reference to the drawings.

### Embodiment

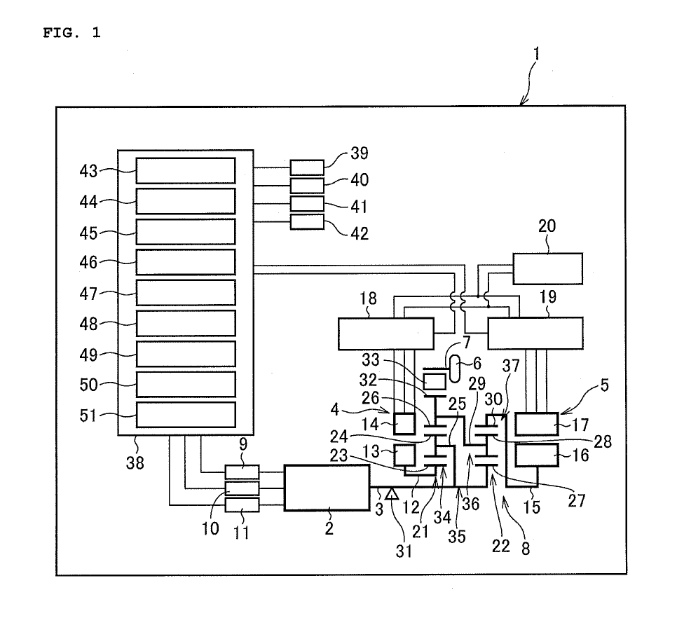

FIGS. 1 to 18 illustrate an embodiment of the present invention. In FIG. 1, reference numeral 1 represents an engine start control device of a hybrid vehicle. The engine start control device 1 of the hybrid vehicle, as a driving system, includes: an output shaft 3 of an engine 2 that generates a driving force in accordance with combustion of fuel; a plurality of a first motor generator 4 and a second motor generator 5 that generate a driving force using electricity and generate electrical energy through driving; a driving shaft 7 that is connected to a drive wheel 6 of the hybrid vehicle, and a differential gear mechanism 8 that is a power transmission system connected to the output shaft 3, the first and second motor generators 4 and 5, and the driving shaft 7.

The engine 2 includes: an air content adjusting means 9 such as a throttle valve that adjusts the air volume to be suctioned in accordance with the amount of the operation of an accelerator (the amount of pressing an accelerator pedal using a foot); a fuel supplying means 10 such as a fuel injection valve that supplies fuel corresponding to the suctioned air volume; and an ignition means 11 such as an ignition device that ignites the fuel. In the engine 2, the combustion state of the fuel is controlled by the air content adjusting means 9, the fuel supplying means 10, and the ignition means 11, and a driving force is generated by the combustion of the fuel.

The first motor generator 4 includes: a first motor rotor shaft 12; a first motor rotor 13; and a first motor stator 14. The second motor generator 5 includes: a second motor rotor shaft 15; a second motor rotor 16; and a second motor stator 17. The first motor stator 14 of the first motor generator 4 is connected to a first inverter 18. The second motor stator 17 of the second motor generator 5 is connected to a second inverter 19.

The power terminals of the first and second inverters 18 and 19 are connected to a battery 20. The battery 20 is an electricity accumulating means that can exchange electric power between the first motor generator 4 and the second motor generator 5. The first motor generator 4 and the second motor generator 5 generate driving forces in accordance with electricity of which the amount of electricity supplied from the battery 20 is controlled by the first and second inverters 18 and 19 and generate electrical energy using the driving force supplied from the drive wheel 6 at the time of regeneration and stores the generated electrical energy in the battery 20 to be charged.

The differential gear mechanism 8 includes a first planetary gear mechanism 21 and a second planetary gear mechanism 22. The first planetary gear mechanism 21 includes: a first sun gear 23; a first planetary carrier 25 supporting the first planetary gear 24 engaged with the first sun gear 23; and a first ring gear 26 that is engaged with the first planetary gear 24. The second planetary gear mechanism 22 includes: a second sun gear 27; a second planetary carrier 29 supporting a second planetary gear 28 engaged with the second sun gear 27; and a second ring gear 30 that is engaged with the second planetary gear 28.

The differential gear mechanism 8 arranges the rotational center lines of rotating components of the first planetary gear mechanism 21 and the second planetary gear mechanism 22 on a same axis, arranges the first motor generator 4 between the engine 2 and the first planetary gear mechanism 21, and arranges the second motor generator 5 on a side of the second planetary gear mechanism 22 that is separated away from the engine 2. The second motor generator 5 can drive the vehicle using only the output thereof.

The first motor rotor shaft 12 of the first motor generator 4 is connected to the first sun gear 23 of the first planetary gear mechanism 21. The first planetary carrier 25 of the first planetary gear mechanism 21 and the second sun gear 27 of the second planetary gear mechanism 22 are connected to the output shaft 3 of the engine 2 in a combined manner through a one-way clutch 31. The first ring gear 26 of the first planetary gear mechanism 21 and the second planetary carrier 29 of the second planetary gear mechanism 22 are combined and are connected to an output unit 32. The output unit 32 is connected to the driving shaft 7 through an output transmission mechanism 33 such as a gear or a chain. The second motor rotor shaft 15 of the second motor generator 5 is connected to the second ring gear 30 of the second planetary gear mechanism 22.

The one-way clutch 31 is a mechanism that fixes the output shaft 3 of the engine 2 so as to rotate only in the output direction and prevents the output shaft 3 of the engine 2 from reversely rotating. The driving power of the second motor generator 5 is transmitted as driving power of the output unit 32 through a reaction force of the one-way clutch 31.

The hybrid vehicle outputs the power generated by the engine 2 and the first and second motor generators 4 and 5 to the driving shaft 7 through the first and second planetary gear mechanisms 21 and 22, thereby driving the drive wheel 6. In addition, the hybrid vehicle transmits the driving force delivered from the drive wheel 6 to the first and second motor generators 4 and 5 through the first and second planetary gear mechanisms 21 and 22, thereby generating electrical energy so as to charge the battery 20.

The differential gear mechanism 8 sets four rotating components 34 to 37. The first rotating component 34 is formed by the first sun gear 23 of the first planetary gear mechanism 21. The second rotating component 35 is formed by combining the first planetary carrier 25 of the first planetary gear mechanism 21 and the second sun gear 27 of the second planetary gear mechanism 22. The third rotating component 36 is formed by combining the first ring gear 26 of the first planetary gear mechanism 21 and the second planetary carrier 29 of the second planetary gear mechanism 22. The fourth rotating component 37 is formed by the second ring gear 30 of the second planetary gear mechanism 22.

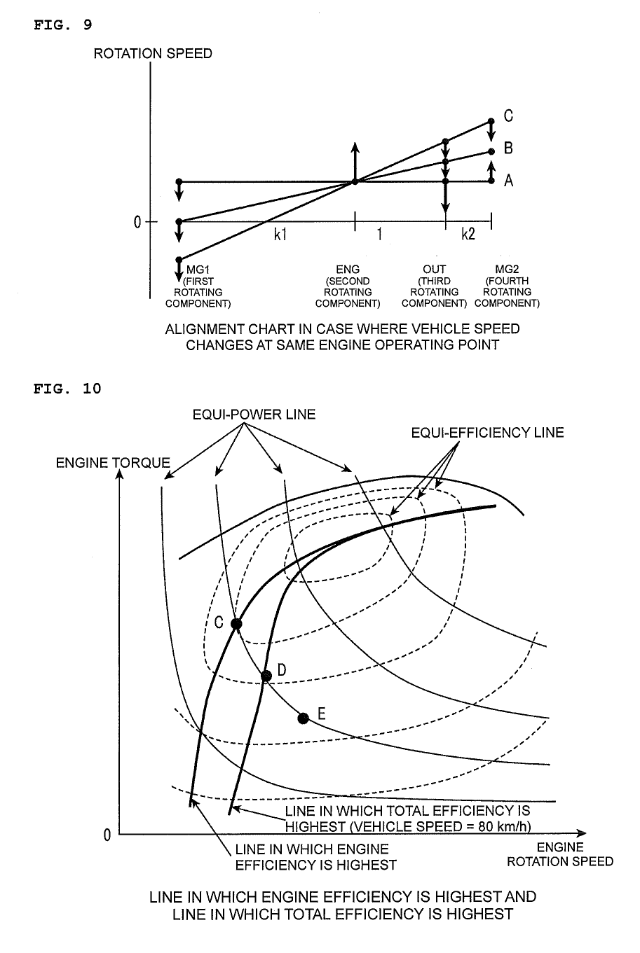

The differential gear mechanism 8, as illustrated in FIGS. 9 and 12 to 17, on an alignment chart in which the rotation speeds of four rotating components 34 to 37 can be represented as a straight line, sets the four rotating components 34 to 37 as the first rotating component 34, the second rotating component 35, the third rotating component 36, and the fourth rotating component 37 from one end (the left side in each figure) toward the other end (the right side in each figure). A ratio of distances among the four rotating components 34 to 37 is represented as k1:1:k2. In each figure, MG1 represents the first motor generator 4, MG2 represents the second motor generator 5, ENG represents the engine 2, and OUT represents the output unit 32.

The first motor rotor shaft 12 of the first motor generator 4 is connected to the first rotating component 34. The output shaft 3 of the engine 2 is connected to the second rotating component 35 through the one-way clutch 31. The output unit 32 is connected to the third rotating component 36. The driving shaft 7 is connected to the output unit 32 through the output transmission mechanism 33. The second motor rotor shaft 15 of the second motor generator 5 is connected to the fourth rotating component 37.

From this, the differential gear mechanism 8 includes the four rotating components 34 to 37 connected to the output shaft 3, the first motor generator 4, the second motor generator 5, and the driving shaft 7 and transmits power and receives power to/from the output shaft 3 of the engine 2, the first motor generator 4, the second motor generator 5, and the driving shaft 7. Accordingly, the engine start control device 1 employs the control form of the “four-axis type”.

The engine start control device 1 for the hybrid vehicle connects the air content adjusting means 9, the fuel supplying means 10, the ignition means 11, the first inverter 18, and the second inverter 19 to the drive control unit 38. In addition, an accelerator operation amount detecting means 39, a vehicle speed detecting means 40, an engine rotation speed detecting means 41, and a battery charge state detecting means 42 are connected to the drive control unit 38.

The accelerator operation amount detecting means 39 detects the amount of the operation of the accelerator that is the amount of pressing the accelerator pedal using a foot. The vehicle speed detecting means 40 detects a vehicle speed of the hybrid vehicle. The engine rotation speed detecting means 41 detects the engine rotation speed of the engine 2. The battery charge state detecting means 42 detects the charge state SOC of the battery 20.

In addition, the drive control unit 38 includes: a target driving force calculating means 43; a target driving power calculating means 44; a target charge/discharge power calculating means 45; a provisional target engine power calculating means 46; a start-time target engine rotation speed calculating means 47; a start-time target engine torque calculating means 48; a target engine power calculating means 49; a target electric power calculating means 50; and a motor torque instruction value calculating means 51.

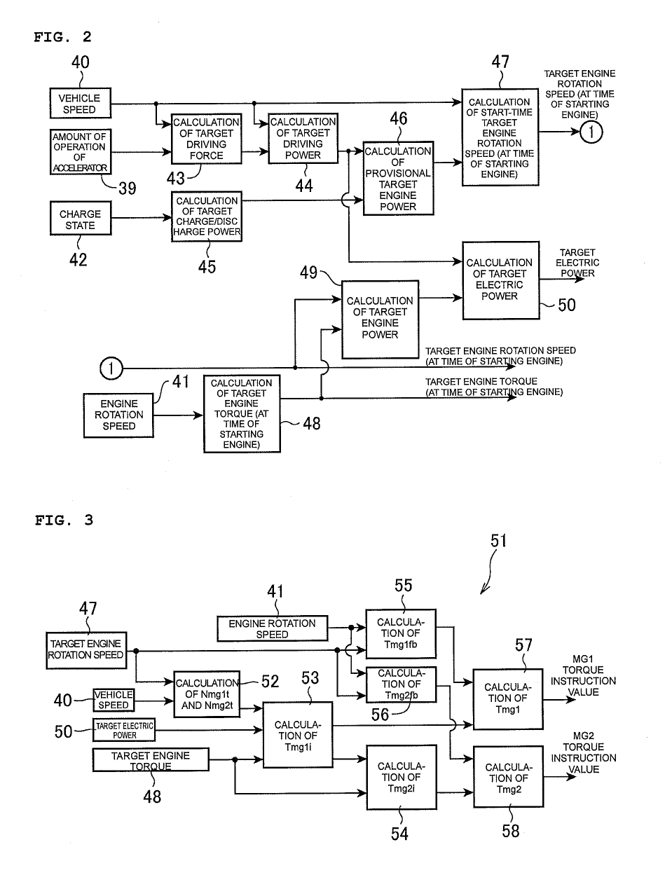

The target driving force calculating means 43, as illustrated in FIG. 2, searches a target driving force search map illustrated in FIG. 6 for the target driving force used for driving the hybrid vehicle in accordance with the amount of the operation of the accelerator detected by the accelerator operation amount detecting means 39 and the vehicle speed detected by the vehicle speed detecting means 40 and determines the target driving force. The target driving force is set to a negative value so as to be a driving force in a deceleration direction corresponding to engine brake in a high vehicle speed region at the accelerator opening degree=0 and is set to a positive value for creep driving in a low vehicle speed region.

The target driving power calculating means 44 calculates target driving power based on the amount of the operation of the accelerator detected by the accelerator operation amount detecting means and the vehicle speed detected by the vehicle speed detecting means 40. In this embodiment, the target driving power is set by multiplying the target driving force set by the target driving force calculating means 43 by the vehicle speed detected by the vehicle speed detecting means 40.

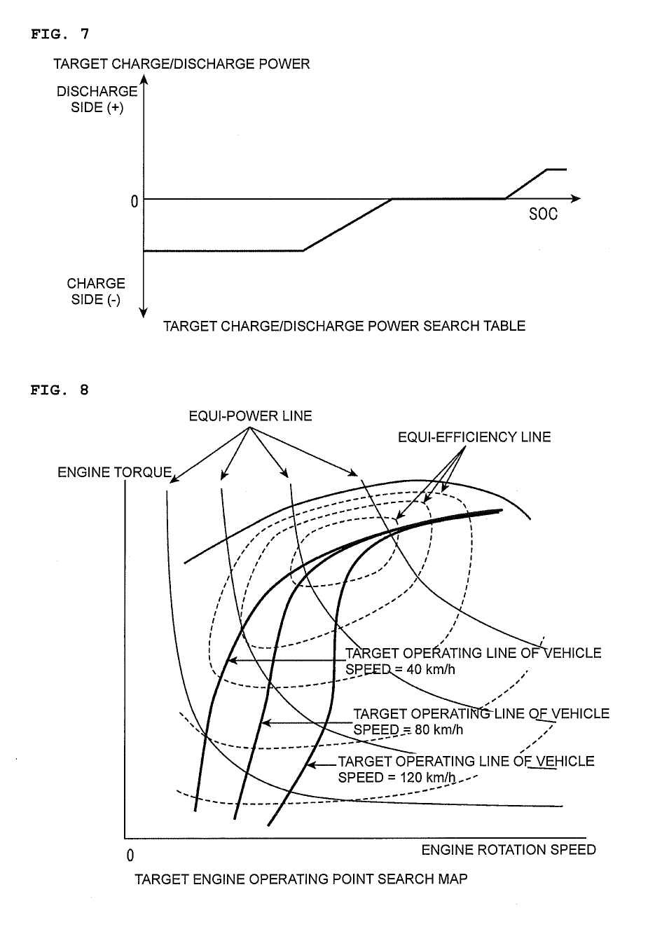

The target charge/discharge power calculating means 45 sets target charge/discharge power based on the charge state SOC of the battery 20 that is detected by the battery charge state detecting means 42. In this embodiment, target charge/discharge power is searched from a target charge/discharge power search table illustrated in FIG. 7 in accordance with the charge state SOC of the battery 20 and the vehicle speed, and the target charge/discharge power is set.

The provisional target engine power calculating means 46 calculates provisional target engine power based on the target driving power calculated by the target driving power calculating means 44 and the target charge/discharge power calculated by the target charge/discharge power calculating means 45.

The start-time target engine rotation speed calculating means 47 calculates a target engine rotation speed at the time of starting the engine. In this embodiment, the start-time target engine rotation speed at the time of staring the engine is calculated based on the provisional target engine power calculated by the provisional target engine power calculating means 46 and the vehicle speed detected by the vehicle speed detecting means 40.

The start-time target engine torque calculating means 48 calculates torque required for cranking the engine 2. In this embodiment, start-time target engine torque at the time of starting the engine is calculated in accordance with an actual engine rotation speed (real engine rotation speed) detected by the engine rotation speed detecting means 41 based on a start-time target engine torque map illustrated in FIG. 18. The start-time target engine torque calculating means 48 sets the start-time target engine torque to engine friction torque at the time of cutting fuel in a case where the engine rotation speed is not near 0 rpm and sets the start-time target engine torque to a large value on the negative side of the engine friction torque in a case where the engine rotation speed is near 0 rpm.

The target engine power calculating means 49 calculates target engine power at the time of starting the engine based on the target engine rotation speed calculated by the start-time target engine rotation speed calculating means 47 and the target engine torque calculated by the start-time target engine torque calculating means 48.

The target electric power calculating means 50 sets a difference between the target driving power calculated by the target driving power calculating means 44 and the target engine power set by the target engine power calculating means 49 as target electric power that is a target value of the input/output electric power of the battery 20.

The motor torque instruction value calculating means 51 calculates torque instruction values of a plurality of the first motor generators 4 and a torque instruction value of the second motor generator 5 by using a torque balance equation including the target engine torque and an electric power balance equation including the target electric power. In this embodiment, the motor torque instruction value calculating means 51 calculates base torque instruction values of the plurality of first motor generators 4 and a base torque instruction value of the second motor generator 5 by using the torque balance equation including the target engine torque and the electric power balance equation including the target electric power, calculates correction torque values based on a difference between the target engine rotation speed calculated by the start-time target engine rotation speed calculating means 47 and the actual engine rotation speed detected by the engine rotation speed detecting means 41, and adds the correction torque values to the base instruction torque values, thereby calculating the torque instruction value of the first motor generator 4 and the torque instruction value of the second motor generator 5.

The torque instruction value of the first motor generator 4 and the torque instruction value of the second motor generator 5 set by the motor torque instruction value calculating means 51, as illustrated in FIG. 3, are calculated by first to seventh calculation units 52 to 58. In FIG. 3, MG1 represents the first motor generator 4, and MG2 represents the second motor generator 5.

The first calculation unit 52 calculates a target rotation speed Nmg1t of the first motor generator 4 and a target rotation speed Nmg2t of the second motor generator 5 in a case where the engine rotation speed is the target engine rotation speed based on the target engine rotation speed calculated by the start-time target engine rotation speed calculating means 47 and the vehicle speed detected by the vehicle speed detecting means 40.

The second calculation unit 53 calculates base torque Tmg1i of the first motor generator 4 based on the target rotation speed Nmg1t of the first motor generator 4 and the target rotation speed Nmg2t of the second motor generator 5, which are calculated by the first calculation unit 52, the target electric power set by the target electric power calculating means 50, and the target engine torque calculated by the start-time target engine torque calculating means 48.

The third calculation unit 54 calculates base torque Tmg2i of the second motor generator 5 based on the base torque Tmg1i of the first motor generator 4 that is calculated by the second calculation unit 53 and the target engine torque calculated by the start-time target engine torque calculating means 48.

The fourth calculation unit 55 calculates feedback correction torque Tmg1fb of the first motor generator 4 based on the engine rotation speed detected by the engine rotation speed detecting means 41 and the target engine rotation speed set by the start-time target engine rotation speed calculating means 47.

The fifth calculation unit 56 calculates feedback correction torque Tmg2fb of the second motor generator 5 based on the engine rotation speed detected by the engine rotation speed detecting means 41 and the target engine rotation speed calculated by the start-time target engine rotation speed calculating means 47.

The sixth calculation unit 57 calculates a torque instruction value Tmg1 of the first motor generator 4 based on the base torque Tmg1i of the first motor generator 4 that is calculated by the second calculation unit 53 and the feedback correction torque Tmg1fb of the first motor generator 4 that is calculated by the fourth calculation unit 55.

The seventh calculation unit 58 calculates a torque instruction value Tmg2 of the second motor generator 5 based on the base torque Tmg2i of the second motor generator 5 that is calculated by the third calculation unit 54 and the feedback correction torque Tmg2fb of the second motor generator 5 that is calculated by the fifth calculation unit 56.

The engine start control device 1 of the hybrid vehicle performs control of the drive states of the air content adjusting means 9, the fuel supplying means 10, and the ignition means 11 such that the engine 2 operates at the target engine rotation speed calculated by the start-time target engine rotation speed calculating means 47 and the target engine torque calculated by the start-time target engine torque calculating means 48 by using the drive control unit 38. In addition, the drive control unit 38 performs control of the drive states of the first and second motor generators 4 and 5 using the torque instruction values calculated by the motor torque instruction value calculating means 51 such that the charge state (SOC) of the battery 20 becomes the target electric power set by the target electric power calculating means 50.

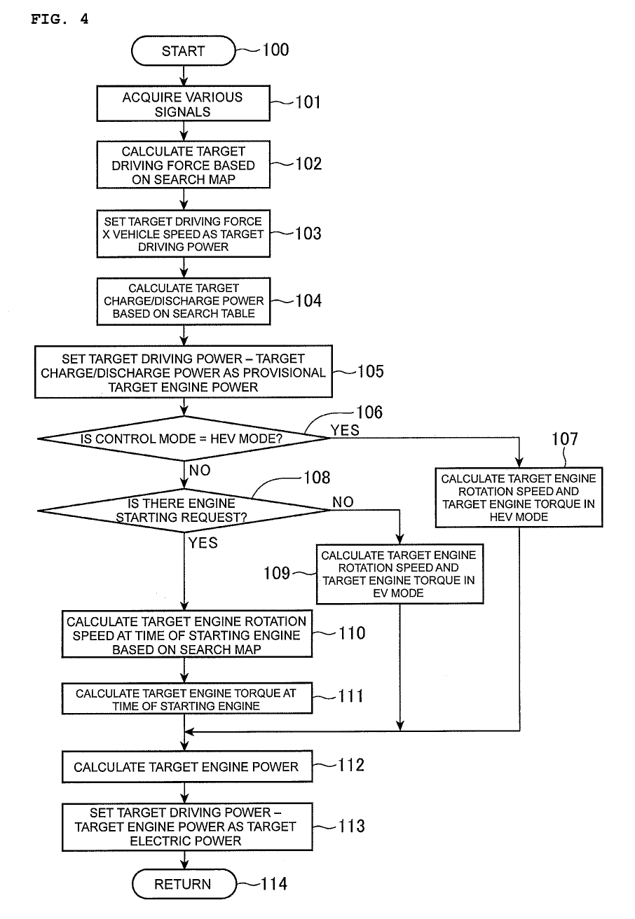

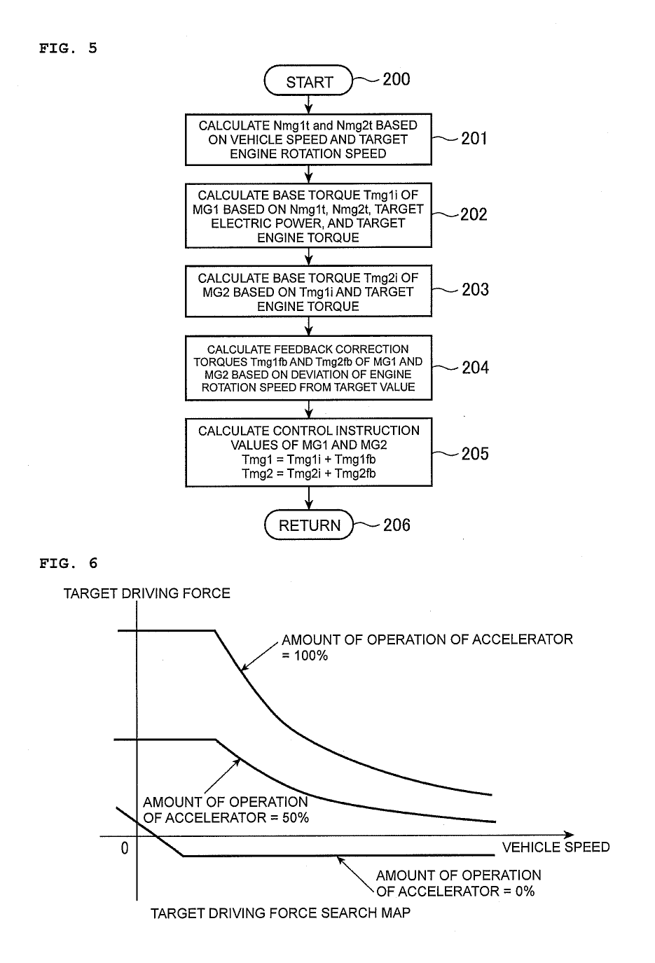

The engine start control device 1 of the hybrid vehicle, as illustrated in the flowchart of controlling the calculation of the target engine operating point represented in FIG. 4, calculates a target engine operating point (the target engine rotation speed and the target engine torque) based on the amount of driver's operation of the accelerator and the vehicle speed and, as illustrated in the flowchart of controlling the calculation of the motor torque instruction value represented in FIG. 5, calculates torque instruction values of the first and second motor generators 4 and 5 based on the target engine operating point.

In the calculation of the target engine operating point (the target engine rotation speed and the target engine torque), as illustrated in FIG. 4, when the control program starts (100), various signals of the detected amount of operation of the accelerator that is detected by the accelerator operation amount detecting means 39, the vehicle speed detected by the vehicle speed detecting means 40, the engine rotation speed detected by the engine rotation speed detecting means 41, and the charge state SOC of the battery 20 that is detected by the battery charge state detecting means 42 are taken in (101), and a target driving force according to the accelerator operation amount and the vehicle speed is calculated based on the target driving force detection map (see FIG. 6) (102).

The target driving force is set to a negative value so as to be a driving force in a deceleration direction corresponding to engine brake in a high vehicle speed region at the amount of the operation of the accelerator=0 and is set to a positive value for creep driving in a low vehicle speed region.

Next, target driving power required for driving the hybrid vehicle with the target driving force is calculated by multiplying the target driving force calculated in Step 102 by the vehicle speed (103) and calculates target charge/discharge power based on the target charge/discharge power search table (see FIG. 7) (104).

In Step 104, in order to control the charge state SOC of the battery 20 in a normal use range, a target charge/discharge amount is calculated based on the target charge/discharge power search table illustrated in FIG. 7. In a case where the charge state SOC of the battery 20 is low, the target charge/discharge power is increased on the charge side so as to prevent excessive discharge of the battery 20. In a case where the charge state SOC of the battery 20 is high, the target charge/discharge power is increased on the discharge side so as to prevent excessive charge. The target charge/discharge power, for the convenience of description, the discharge side is set as a positive value, and the charge side is set as a negative value.

In Step 105, power (provisional target engine power) to be output by the engine 2 is calculated based on the target driving power and the target charge/discharge power. The power to be output by the engine 2 has a value acquired by adding (subtracting in the case of discharge) the power required for charging the battery 20 to the power required for driving the hybrid vehicle. Here, since the charge side is handled as a negative value, the target engine power is calculated by subtracting the target charge/discharge power from the target driving power.

In Step 106, it is determined whether the control mode is an HEV mode. The HEV mode is a mode in which driving is performed by operating the engine 2. In a case where the control mode is the HEV mode (Yes in 106), the process proceeds to Step 107. On the other hand, in a case where the control mode is not the HEV mode (No in 106), the process proceeds to Step 108.

In Step 107, a target engine operating point (a target engine rotation speed and target engine torque) in the case of the HEV mode is calculated, and the process proceeds to Step 112. The target engine operating point is set based on the target engine power and the total system efficiency and, for example, is acquired by searching a target engine operating point search map illustrated in FIG. 8. The detailed calculation method will not be presented.

In Step 108, it is determined whether there is an engine starting request. In a case where there is no engine starting request (No in 108), the process proceeds to Step 109. On the other hand, in a case where there is an engine starting request (Yes in 108), the process proceeds to Steps 110 and 111, and a target engine rotation speed and target engine torque at the time of starting engine are calculated.

In Step 109, a target engine operating point (a target engine rotation speed and target engine torque) in the case of an EV mode (the mode in which driving is performed by operating the first and second motor generators 4 and 5) is calculated, and the process proceeds to Step 112. For example, in the EV mode, the target engine rotation speed=0 rpm, and the target engine torque=0 Nm. The detailed calculation method will not be presented.

In Step 110, a target engine rotation speed at the time of starting the engine is calculated. As the calculation method, the target engine rotation speed may be calculated in accordance with the provisional target engine power and the vehicle speed based on the target engine operating point search map illustrated in FIG. 8.

Here, the target engine operating point search map (FIG. 8) will be described. The target engine operating point search map selects points at which the total efficiency acquired by adding the efficiency of the power transmission system configured by the differential gear mechanism 8 and the first and second motor generators 4 and 5 to the efficiency of the engine 2 is high on the equi-power line increases for each power level and sets a line acquired by joining the points as a target engine operating line. Each target engine operating line is set for each vehicle speed (40 km/h, 80 km/h, and 120 km/h in FIG. 8). The set value of the target engine operating line may be acquired through an experiment or may be acquired through a calculation that is based on the efficiency of each one of the engine 2 and the first and second motor generators 4 and 5. In addition, the target engine operating line is set to move to the high rotation side as the vehicle speed increases at the same target engine power.

The reason for this is as follows.

In a case where the same engine operating point is set as the target engine operating point regardless of the vehicle speed, as illustrated in FIG. 9, the rotation speed of the first motor generator 4 is positive in a case where the vehicle speed is low, and the first motor generator 4 serves as a power generator, and the second motor generator 5 serves as an electric motor (A). Then, as the vehicle speed increases, the rotation speed of the first motor generator 4 approaches zero (B), and, when the vehicle speed further increases, the rotation speed of the first motor generator 4 becomes negative. In this state, the first motor generator 4 operates as an electric motor, and the second motor generator 5 operates as a power generator (C).

In a case where the vehicle speed is low (states A and B), since the circulation of the power does not occur, and the target engine operating, like the target engine operating line of the vehicle speed=40 km/h illustrated in FIG. 8, is close to a point at which the efficiency of the engine 2 is high on the whole.

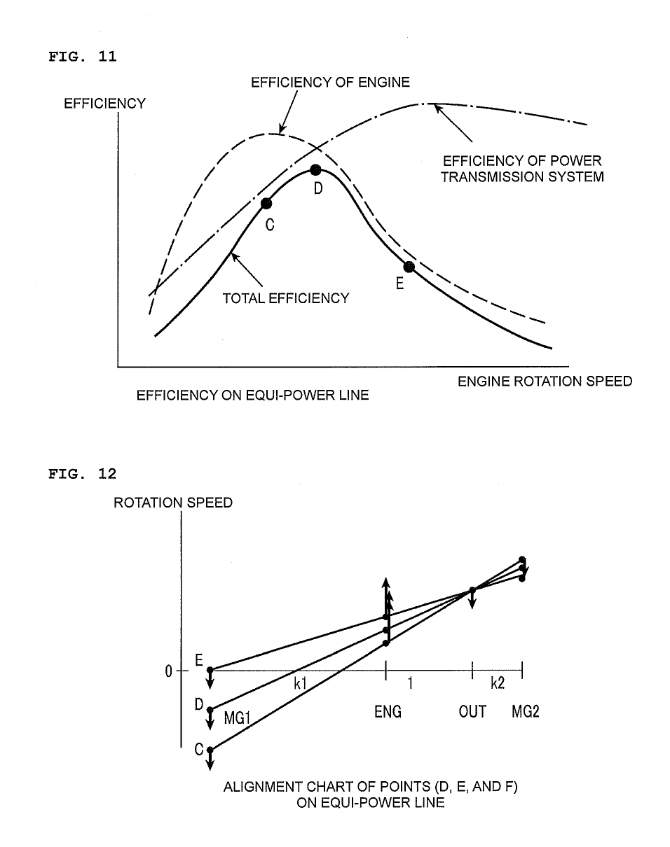

However, in a case where the vehicle speed is high (state C), the first motor generator 4 operates as an electric motor, the second motor generator 5 operates as a power generator, and accordingly, the circulation of the power occurs, whereby the efficiency of the power transmission system is lowered. Accordingly, as illustrated at a point C illustrated in FIG. 11, the efficiency of the power transmission system is lowered even when the efficiency of the engine 2 is high, and accordingly, the total efficiency is lowered.

Thus, in order not to cause the circulation of power to occur in the high vehicle speed region, like E in the alignment chart illustrated in FIG. 12, the rotation speed of the first motor generator 4 may be set to zero or higher. However, in such a case, the engine operating point moves in a direction in which the engine rotation speed of the engine 2 increases. Thus, as illustrated in point E illustrated in FIG. 11, even when the efficiency of the power transmission system is high, the efficiency of the engine 2 is lowered much, whereby the total efficiency is lowered.

Accordingly, as illustrated in FIG. 11, a point at which the total efficiency is high is D therebetween, and, by setting this point as the target engine operating point, an operation having the highest efficiency can be performed.

As above, in FIG. 10, three engine operating points C, D, and E are represented on the target engine operating point search map. It can be understood that an operating point at which the total efficiency is the highest moves to a further high rotation side than an operating point at which the engine efficiency is the highest in a case where the vehicle speed is high.

Following Step 110 described above, in Step 111, target engine torque at the time of starting the engine is calculated based on the target engine rotation speed acquired in Step 110. As a calculation method thereof, target engine torque at the time of starting the engine is calculated in accordance with the engine rotation speed based on the start-time target engine torque search map illustrated in FIG. 18. The start-time target engine torque search map is a value set in advance based on the engine friction torque at the time of cutting the fuel so as to crank the engine 2. In addition, for an engine rotation speed near 0 rpm, a large value on the negative side of the engine friction torque is set in consideration of a coefficient of static friction.

In Step 112, target engine power is calculated based on the target engine rotation speed and the target engine torque at the time of starting the engine, which have been calculated in Steps 110 and 111. In addition, In Step 112, target engine power is calculated based on the target engine rotation speed and the target engine torque in the HEV mode, which have been calculated in Step 107, and target engine power is calculated based on the target engine rotation speed and the target engine torque in the EV mode, which have been calculated in Step 109.

In Step 113, the target engine power calculated in Step 112 is subtracted from the target driving power calculated in Step 103, whereby target electric power (at the time of starting the engine, in the HEV mode, or in the EV mode) is calculated. After the calculation of the target electric power, the process is returned (114). In a case where the target driving power is higher than the target engine power, the target electric power has a value representing the assistance power according to the electric power of the battery 20. On the other hand, in a case where the target engine power is higher than the target driving power, the target electric power has a value representing charge electric power for charging the battery 20.

Next, the calculation of torque instruction values that are the target torque of the first motor generator 4 and the target torque of the second motor generator 5 used for setting the amount of charge/discharge of the battery 20 as a target value while the target driving force is output will be described along the flowchart of controlling the calculation of the motor torque instruction values illustrated in FIG. 5 will be described. In FIG. 5, MG1 represents the first motor generator 4, and MG2 represents the second motor generator 5.

In the calculation of the motor torque instruction values, as illustrated in FIG. 5, when a control program starts (200), first, in Step 201, the driving shaft rotation speed No of the driving shaft 7 to which the first and second planetary gear mechanisms 21 and 22 are connected is calculated based on the vehicle speed. Next, the target rotation speed Nmg1t of the first motor generator 4 and the target rotation speed Nmg2t of the second motor generator 5 in a case where the engine rotation speed Ne is the target engine rotation speed Net are calculated by using the following Equations (1) and (2). These Equations (1) and (2) for the calculation are acquired based on the relation between the rotation speeds of the first and second planetary gear mechanisms 21 and 22.

Nmg1t=(Net−No)*k1+Net Equation (1)

Nmg2t=(No−Net)*k2+No Equation (2)

Here, k1 and k2, as will be described later, are values that are determined based on the gear ratio between the first and second planetary gear mechanisms 21 and 22.

Next, in Step 202, base torque Tmg1i of the first motor generator 4 is calculated by using the following Equation (3) based on the target rotation speed Nmg1t of the first motor generator 4 and the target rotation speed Nmg2t of the second motor generator 5, which have been acquired in Step 201, and the target electric power Pbatt calculated by the target electric power calculating means 50, and the target engine torque Tet calculated by the start-time target engine torque calculating means 48.

Tmg1i=(Pbatt*60/2π−Nmg2t*Tet/k2)/(Nmg1t+Nmg2t*(1+k1)/k2) Equation (3)

This Equation (3) for the calculation can be derived by solving certain simultaneous equations formed by a torque balance equation (4) representing the balance of torques input to the first and second planetary gear mechanisms 21 and 22 and an electric power balance equation (5) representing that the electric power generated or consumed by the first and second motor generators 4 and 5 and the input/output electric power (Pbatt) of the battery 20 are the same.

Tet+(1+k1)*Tmg1=k2*Tmg2 Equation (4)

Nmg1*Tmg1*2π/60+Nmg2*Tmg2*2π/60=Pbatt Equation (5)

Next, in Step 203, the base torque Tmg2i of the second motor generator 5 is calculated by using the following Equation (6) based on the base torque Tmg1i of the first motor generator 4 and the target engine torque Tet.

Tmg2i=(Tet+(1+k1)*Tmg1i)/k2 Equation (6)

This equation is derived from Equation (4) described above.

Next, in Step 204, in order to make the engine rotation speed approach the target, the feedback correction torque Tmg1fb of the first motor generator 4 and the feedback correction torque Tmg2fb of the second motor generator 5 are calculated by multiplying the deviation between the engine rotation speed Ne from the target engine rotation speed Net by a predetermined feedback gain set in advance.

In Step 205, a torque instruction value Tmg1 that is a control instruction value of the first motor generator 4 is calculated by adding the feedback correction torque Tmg1fb of the first motor generator 4 to the base torque Tmg1i, a torque instruction value Tmg2 that is a control instruction value of the second motor generator 5 is calculated by adding the feedback correction torque Tmg2fb of the second motor generator 5 to the base torque Tmg2i, and the process is returned (206).

By controlling the first and second motor generators 4 and 5 based on the torque instruction values Tmg1 and Tmg2, the drive control unit 38 can start the engine 2 while outputting the target driving force. In addition, the drive control unit 38 can set the charge/discharge of the battery 20 to a target value.

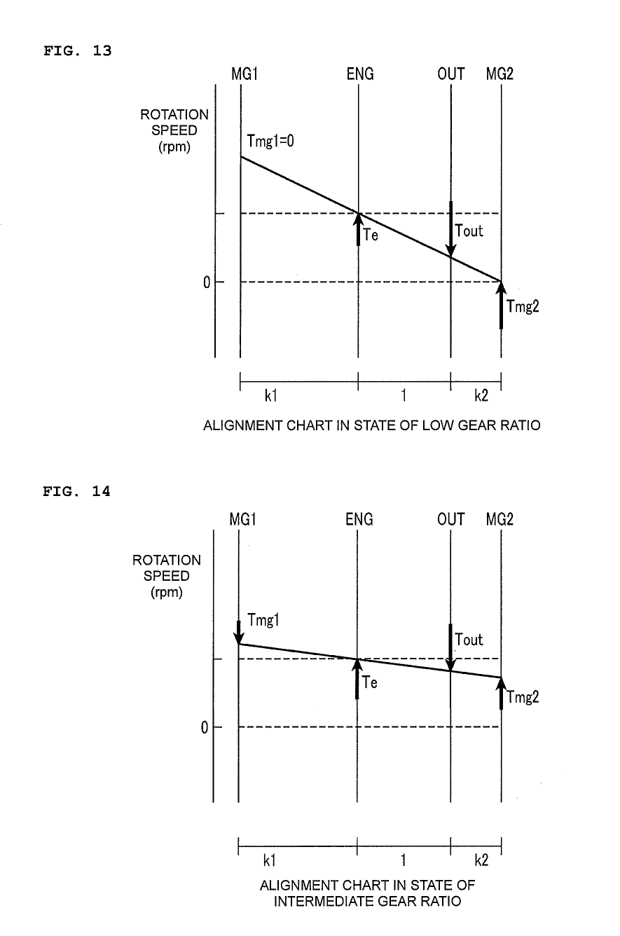

FIGS. 13 to 16 illustrate alignment charts in representative operation states. In the alignment charts, four rotating components 34 to 37 of the differential gear mechanism 8 formed by the first and second planetary gear mechanisms 21 and 22 are aligned in order of the first rotating component 34 connected to the first motor generator 4 (MG1), the second rotating component 35 connected to the engine 2 (ENG), the third rotating component 36 connected to the driving shaft 7 (OUT), and the fourth rotating component 37 connected to the second motor generator 5 (MG2) in the alignment chart, and the mutual lever ratio among the rotating components 34 to 37 is arranged to be k1:1:k2 in the same order.

Here, values k1 and k2 determined based on the gear ratio of the differential gear mechanism 8 formed by the first and second planetary gear mechanisms 21 and 22 are defined as below.

k1=ZR1/ZS1
k2=ZS2/ZR2
ZS1: the number of teeth of first sun gear
ZR1: the number of teeth of first ring gear
ZS2: the number of teeth of second sun gear
ZR2: the number of teeth of second ring gear

Next, the operation states will be described using an alignment chart. In the rotation speed, the rotation direction of the output shaft 3 of the engine 2 is set as a positive direction. In addition, in the torque that is input/output to/from each shaft, a direction in which torque having the same direction as that of the torque of the output shaft 3 of the engine 2 is input is defined as positive. Accordingly, in a case where the torque of the driving shaft 7 is positive, a state is formed in which torque for driving the hybrid vehicle to the rear side is output (deceleration at the time of forward driving and driving at the time of backward driving). On the other hand, in a case where the torque of the driving shaft 7 is negative, a state is formed in which torque for driving the hybrid vehicle to the front side is output (driving at the time of forward driving, and deceleration at the time of backward driving).

In a case where power generation or backward driving (acceleration by transmitting power to the drive wheel 7 or maintaining a balanced speed on an ascending slope) is performed by the first and second motor generators 4 and 5, there are losses due to heat generation in the first and second inverters 18 and 19 and the first and second motor generators 4 and 5, and accordingly, the efficiency is not 100% in a case where a conversion between electric energy and mechanical energy is made. However, for the simplification of description, it is assumed that there is no loss. In a case where the loss is considered for practical implementation, power generation is controlled so as to additionally generate power corresponding to the energy consumed due to the loss.

### (1) Low Gear Ratio State (FIG. 13)

Driving is performed using the engine 2, and a state is formed in which the rotation speed of the second motor generator 5 is zero. The alignment chart at this time is illustrated in FIG. 13. Since the rotation speed of the second motor generator 5 is zero, no power is consumed. Thus, in a case where there is no charge/discharge of the battery 20, power generation using the first motor generator 4 does not need to be performed, and the torque instruction value Tmg1 of the first motor generator 4 is zero.

In addition, the ratio between the engine rotation speed of the output shaft 3 and the driving shaft rotation speed of the driving shaft 7 is (1+k2)/k2.

### (2) Intermediate Gear Ratio State (FIG. 14)

Driving is performed using the engine 2, and a state is formed in which the rotation speeds of the first and second motor generators 4 and 5 are positive. The alignment chart at this time is illustrated in FIG. 14. In this case, in a case where there is no charge/discharge of the battery 20, the first motor generator 4 is regenerated, and the second motor generator 5 is reversely operated using the regenerated electric power.

### (3) High Gear Ratio State (FIG. 15)

Driving is performed using the engine 2, and a state is formed in which the rotation speed of the first motor generator 4 is zero. The alignment chart at this time is illustrated in FIG. 15. Since the rotation speed of the first motor generator 4 is zero, regeneration is not performed. Accordingly, in a case where there is no charge/discharge of the battery 20, the reverse operation or the regeneration is not performed by the second motor generator 5, and the torque instruction value Tmg2 of the second motor generator 5 is zero.

In addition, the ratio between the engine rotation speed of the output shaft 3 and the driving shaft rotation speed of the driving shaft 7 is k1/(1+k1).

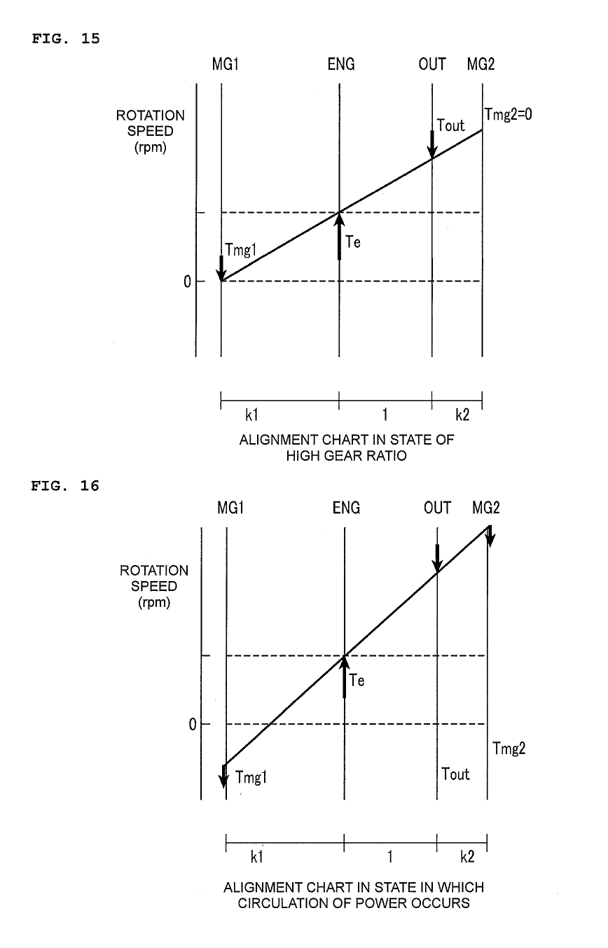

(4) State in which Power Circulation is Performed (FIG. 16)

In a state in which the vehicle speed is higher than the high gear ratio state, a state is formed in which the first motor generator 4 is reversely rotated (FIG. 16). In this state, the first motor generator 4 is reversely operated, thereby consuming the electric power. Accordingly, in a case where there is no charge/discharge of the battery 20, the second motor generator 5 is regenerated and performs power generation.

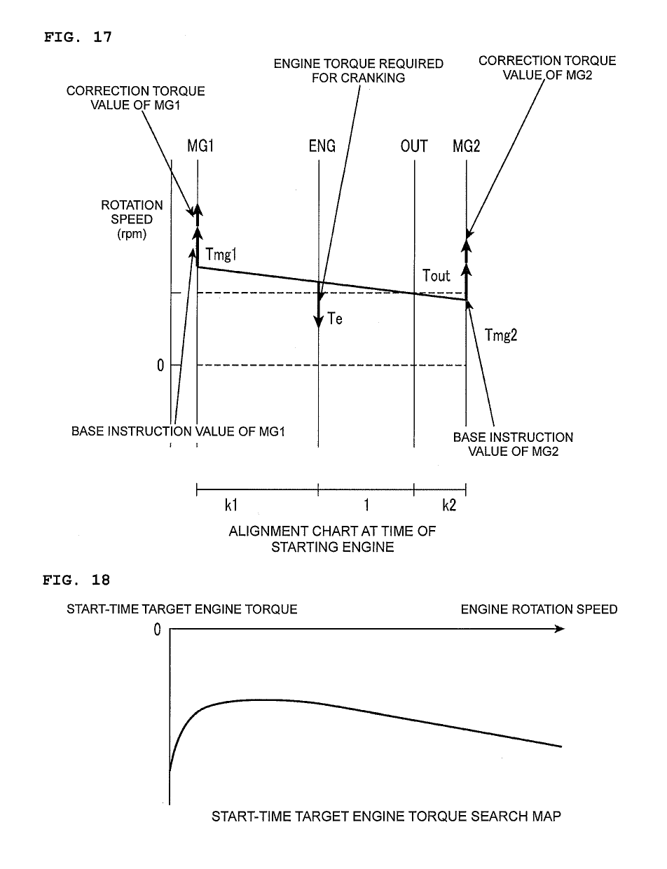

FIG. 17 illustrates an alignment chart at the time of starting the engine. The base instruction torque values of the first and second motor generators 4 and 5 are calculated so as to be balanced with engine torque required for cranking the engine 2. In addition, the correction torque values of the first and second motor generators 4 and 5 are calculated such that there is no variation in the torque of the driving shaft 7.

As above, in the engine start control device 1 of the hybrid vehicle, a target engine rotation speed at the time of starting the engine is calculated by the start-time target engine rotation speed calculating means 47, torque required for cranking the engine 2 is calculated by the start-time target engine torque calculating means 48, target engine power is calculated based on the target engine rotation speed and the target engine torque by the target engine power calculating means 49, target driving power is calculated based on the amount of the operation of the accelerator and the vehicle speed by the target driving power calculating means 44, a difference between the target driving power and the target engine power is set as target electric power by the target electric power calculating means 50, and instruction torque values of the first and second motor generators 4 and 5 are calculated using the torque balance equation including the target engine torque and the electric power balance equation including the target electric power by the motor torque instruction value calculating means 51.

From this, the engine start control device 1 can start the engine 2 while outputting a driving force requested from a driver.

In addition, the engine start control device 1 of the hybrid vehicle calculates base instruction torque values of the first and second motor generators 4 and 5 using the torque balance equation including the target engine torque and the electric power balance equation including the target electric power by using the motor torque instruction value calculating means 51, calculates correction torque values based on the difference between the target engine rotation speed and the engine rotation speed, and calculates torque instruction values of the first and second motor generators 4 and 5 by adding the correction torque values to the base instruction torque values.

From this, the engine start control device 1 can generate torques in the first and second motor generators 4 and 5 so as to be balanced with the engine torque required for cranking the engine 2. In addition, the engine start control device 1 corrects for the torques of the first and second motor generators 4 and 5 based on a difference between the target engine rotation speed and the actual engine rotation speed and accordingly, can prevent variations in the torque of the driving shaft 7.

Furthermore, the engine start control device 1 calculates a target driving force based on the amount of the operation of the accelerator and the vehicle speed by using the target driving force calculating means 43, calculates target charge/discharge power based on the charge state of the battery 20 by using the target charge/discharge power calculating means 45, calculates provisional target engine power based on the target driving power and the target charge/discharge power by using the provisional target engine power calculating means 46, calculates target driving power by multiplying the target driving force by the vehicle speed by using the target driving power calculating means 44, and calculates a target engine rotation speed at the time of starting the engine based on the provisional target engine power and the vehicle speed by using the start-time target engine rotation speed calculating means 47.

From this, the engine start control device 1 can calculate the target engine rotation speed at the time of starting the engine with high accuracy and can maintain the charge state SOC of the battery 20 within a predetermined range.

In addition, the engine start control device 1 sets the torque to the engine friction torque at the time of cutting the fuel at an engine rotation speed not near 0 rpm and sets the torque to a large value on the negative side of the engine friction torque at an engine rotation speed near 0 rpm by using the start-time target engine torque calculating means 48, whereby appropriate engine cranking torque can be output at the time of starting the engine.

### INDUSTRIAL APPLICABILITY

According to the present invention, an engine can be started while a driving force requested from a driver is output, and the present invention can be applied to the control of a hybrid vehicle at the time of starting the engine.

### REFERENCE SIGNS LIST

1 engine start control device of hybrid vehicle
2 engine
3 output shaft
4 first motor generator
5 second motor generator
7 driving shaft
8 differential gear mechanism
18 first inverter
19 second inverter
20 battery
21 first planetary gear mechanism
22 second planetary gear mechanism
31 one-way clutch
32 output unit
34 first rotating component
35 second rotating component
36 third rotating component
37 fourth rotating component
38 drive control unit
39 accelerator opening detecting means
40 vehicle speed detecting means
41 engine rotation speed detecting means
42 battery charge state detecting means
43 target driving force calculating means
44 target driving power calculating means
45 target charge/discharge power calculating means
46 provisional target engine power calculating means
47 start-time target engine rotation speed calculating means
48 start-time target engine torque calculating means
49 target engine power calculating means
50 target electric power calculating means
51 motor torque instruction value calculating means

1. An engine start control device of a hybrid vehicle that controls driving of the vehicle using outputs of an engine and a plurality of motor generators, the engine start control device comprising:
a start-time target engine rotation speed calculating means that calculates a target engine rotation speed at the time of starting the engine;
a start-time target engine torque calculating means that calculates torque required for cranking the engine;
a target engine power calculating means that calculates target engine power based on the target engine rotation speed calculated by the start-time target engine rotation speed calculating means and the target engine torque calculated by the start-time target engine torque calculating means;
an accelerator operation amount detecting means that detects an amount of an operation of an accelerator of the vehicle;
a vehicle speed detecting means that detects a vehicle speed;
a target driving power calculating means that calculates target driving power based on the amount of the operation of the accelerator detected by the accelerator operation amount detecting means and the vehicle speed detected by the vehicle speed detecting means;
a target electric power calculating means that sets a difference between the target driving power calculated by the target driving power calculating means and the target engine power calculated by the target engine power calculating means as target electric power; and
a motor torque instruction value calculating means that calculates instruction torque values of a plurality of motor generators using a torque balance equation including the target engine torque and an electric power balance equation including the target electric power.

2. The engine start control device of a hybrid vehicle according to claim 1, further comprising an engine rotation speed detecting means that detects an engine rotation speed,
wherein the motor torque instruction value calculating means calculates base instruction torque values of the plurality of motor generators using the torque balance equation including the target engine torque and the electric power balance equation including the target electric power, calculates correction torque values based on a difference between the target engine rotation speed calculated by the start-time target engine rotation speed calculating means and actual engine rotation speed detected by the engine rotation speed detecting means, and calculates torque instruction values of the plurality of motor generators by adding the correction torque values to the base instruction torque values.

3. The engine start control device of a hybrid vehicle according to claim 1, further comprising:
a target driving force calculating means that calculates a target driving force based on the amount of the operation of the accelerator detected by the accelerator operation amount detecting means and the vehicle speed detected by the vehicle speed detecting means;
a battery charge state detecting means that detects a charge state of the battery;
a target charge/discharge power calculating means that calculates target charge/discharge power based on the charge state of the battery detected by the battery charge state detecting means; and
a provisional target engine power calculating means that calculates provisional target engine power based on the target driving power calculated by the target driving power calculating means and the target charge/discharge power calculated by the target charge/discharge power calculating means,
wherein the target driving power calculating means calculates the target driving power by multiplying the target driving force calculated by the target driving force calculating means by the vehicle speed detected by the vehicle speed detecting means, and
wherein the start-time target engine rotation speed calculating means calculates the target engine rotation speed at the time of starting the engine based on the provisional target engine power calculated by the provisional target engine power calculating means and the vehicle speed detected by the vehicle speed detecting means.

4. The engine start control device of a hybrid vehicle according to claim 1, wherein the start-time target engine torque calculating means sets torque to engine friction torque at the time of fuel cut for an engine rotation speed that is not near 0 rpm and sets torque to a large value on the negative side of the engine friction torque for an engine rotation speed near 0 rpm.
